(19) United States
(12) Patent Application Publication
(10) Pub. No.: US 2023/0052990 A1
(43) Pub. Date: Feb. 16, 2023

(54) ELECTRIC POWER STEERING APPARATUS

(71) Applicant: Mando Corporation, Pyeongtaek-si (KR)

(72) Inventors: Kyung Min KO, Seongnam-si (KR); Hyoung Woo KIM, Seoul (KR)

(73) Assignee: Mando Corporation, Pyeongtaek-si (KR)

(21) Appl. No.: 17/881,778

(22) Filed: Aug. 5, 2022

(30) Foreign Application Priority Data
Aug. 10, 2021 (KR) 10-2021-0104994

(51) Int. Cl. B62D 5/04

(52) U.S. Cl. CPC B62D 5/0448; B62D 5/0409

(57) ABSTRACT

An electric power steering apparatus according to the embodiments of the present disclosure may comprise a ball screw having an outer screw groove formed on its outer circumferential surface, a ball nut having a gear portion formed on one side of the outer circumferential surface and an inner screw groove corresponding to the outer screw groove formed on the inner circumferential surface, coupled to the ball screw through a ball and sliding in the axial direction, a sector shaft having a shaft gear coupled to the gear portion of the ball nut on an outer circumferential surface and rotating when the ball nut slides in an axial direction, and a sliding support member coupled to the outer circumferential surface of the ball nut, supported on an inner circumferential surface of a housing, and axially slid together with the ball nut.

### CROSS REFERENCE TO RELATED APPLICATION

This application claims the benefit and priority from Korean Patent Application No. 10-2021-0104994, filed in the Republic of Korea on Aug. 10, 2021, the entire contents of which are hereby incorporated by reference for all purposes as if fully set forth into the present application.

### BACKGROUND

### Technical Field

Embodiments of the present disclosure relate to an electric power steering apparatus, and more particularly, to an electric power steering apparatus that can transmit the amplified steering torque through a reducer even in the case of a truck or bus requiring a relatively large steering force compared to a passenger vehicle, and enhance the driver's convenience by improving the durability of power transmission parts such as ball nuts, ball screws, sector shafts, and housings.

### Description of the Related Art

In general, the steering apparatus of a vehicle is a device for changing the direction of the vehicle at the will of the driver. This is a device that assists the driver to advance the vehicle in a desired direction by arbitrarily changing the rotational center of the front wheel of the vehicle.

On the other hand, a power steering apparatus is a device that allows the vehicle's traveling direction to be easily changed with less force, when the driver operates the steering wheel a booster is used to assist the driver with the steering wheel operation force.

Such a power steering apparatus is largely divided into an electric power steering apparatus (EPS) and a hydraulic power steering apparatus (HPS).

In the hydraulic power steering apparatus, the hydraulic pump connected to the engine's rotating shaft supplies hydraulic oil to the operating cylinder connected to the rack bar so that the driver can steer with a small force. As the piston of the working cylinder supplied with hydraulic oil moves, it assists the steering operation force.

On the other hand, the electric power steering apparatus is a steering system that assists the steering wheel's operating force with the power of the motor because it has a motor instead of a hydraulic pump and an operating cylinder.

However, in the case of trucks or buses that require relatively large steering force compared to passenger cars, hydraulic power steering apparatus is used for the reason that high output is required. Since the hydraulic power steering apparatus does not have an electronic control device, there is a problem that functions such as automatic parking, lane keeping, and autonomous driving using the electronic control device cannot be used.

Therefore, even in the case of trucks or buses that require a relatively large steering force compared to passenger cars, the need to enable automatic parking, lane keeping, and autonomous driving using electronic control devices is emerging. And there is a need for improving the driver's convenience by transmitting the amplified steering torque and improving the durability of the power transmission part.

### SUMMARY

Embodiments of the present disclosure may provide an electric power steering apparatus that transmits the amplified steering torque through the reducer even in the case of a truck or bus that requires a relatively large steering force compared to a passenger car. Embodiments of the present disclosure may provide an electric power steering apparatus that can enhance the driver's convenience by improving the durability of power transmission parts such as ball nuts, ball screws, sector shafts, and housings.

In addition, the purpose of embodiments of the present disclosure is not limited thereto, and other objects not mentioned will be clearly understood by those skilled in the art from the following description.

An electric power steering apparatus according to the embodiments of the present disclosure may comprise a ball screw having an outer screw groove formed on its outer circumferential surface, a ball nut having a gear portion formed on one side of the outer circumferential surface and an inner screw groove corresponding to the outer screw groove formed on the inner circumferential surface, coupled to the ball screw through a ball and sliding in the axial direction, a sector shaft having a shaft gear coupled to the gear portion of the ball nut on an outer circumferential surface and rotating when the ball nut slides in an axial direction, and a sliding support member coupled to the outer circumferential surface of the ball nut, supported on an inner circumferential surface of a housing, and axially slid together with the ball nut.

According to embodiments of the present disclosure, the amplified steering torque is transmitted through the reducer in the case of a truck or bus that requires a relatively large steering force compared to a passenger car, and it is possible to increase the convenience of the driver by improving the durability of power transmission parts such as ball nuts, ball screws, sector shafts, and housings.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a schematic view illustrating an electric power steering apparatus according to the embodiments of the present disclosure;

FIGS. 2 to 4 are perspective views illustrating an electric power steering apparatus according to the embodiments of the present disclosure;

FIGS. 5 and 6 are exploded perspective views illustrating an electric power steering apparatus according to the embodiments of the present disclosure;

FIG. 7 is a cross-sectional view illustrating an electric power steering apparatus according to the embodiments of the present disclosure;

FIG. 8 is a exploded perspective view illustrating an electric power steering apparatus according to the embodiments of the present disclosure;

FIGS. 9 and 10 are cross-sectional views illustrating an electric power steering apparatus according to the embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

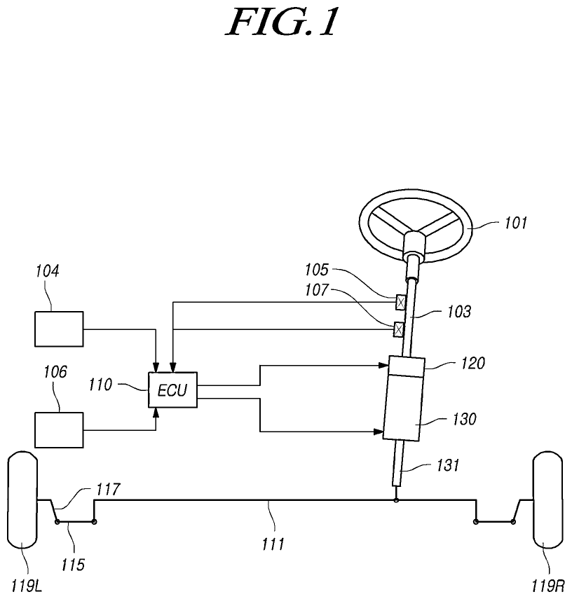

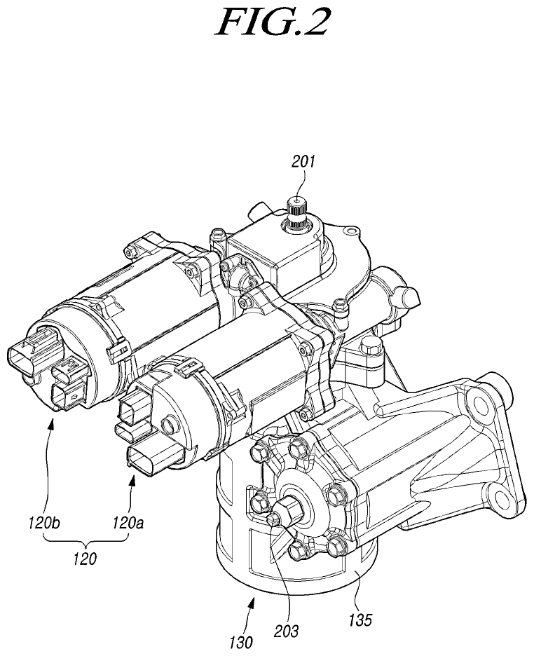

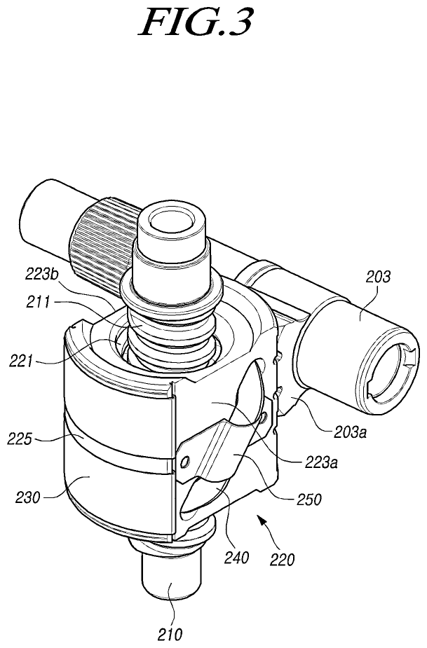

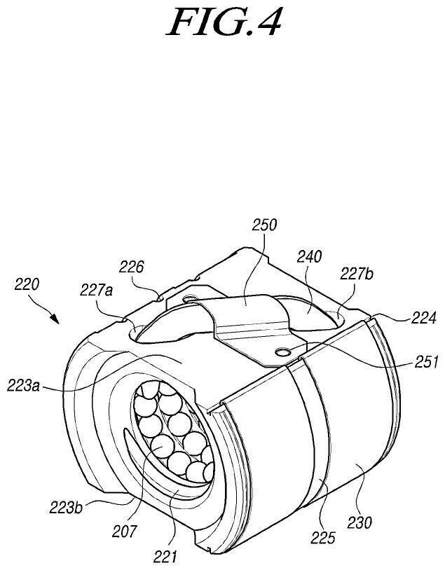

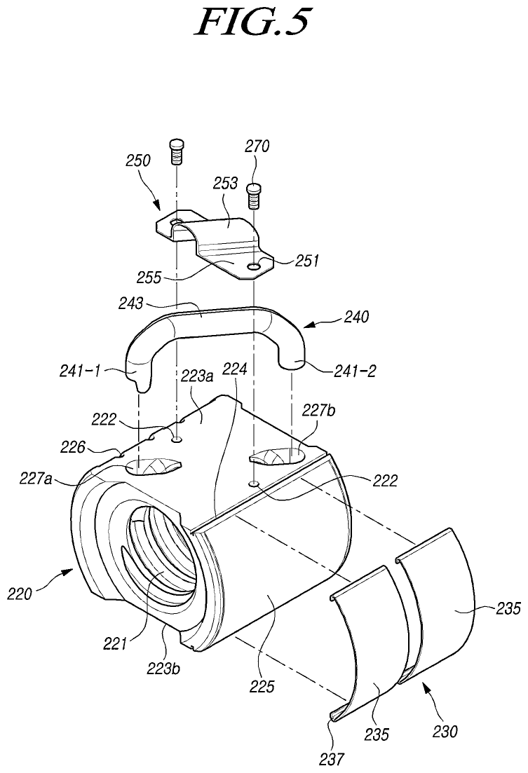

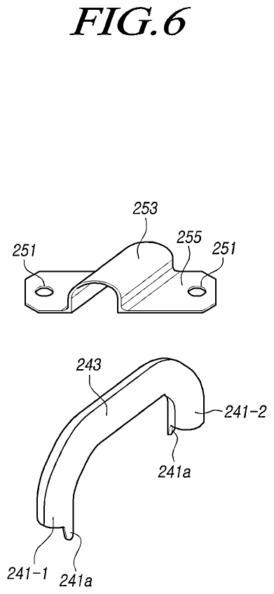

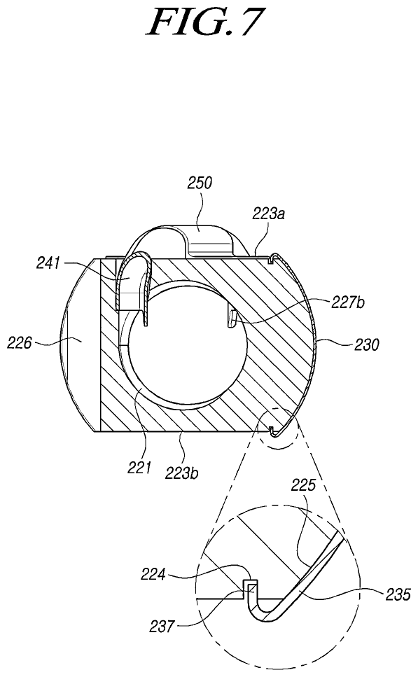

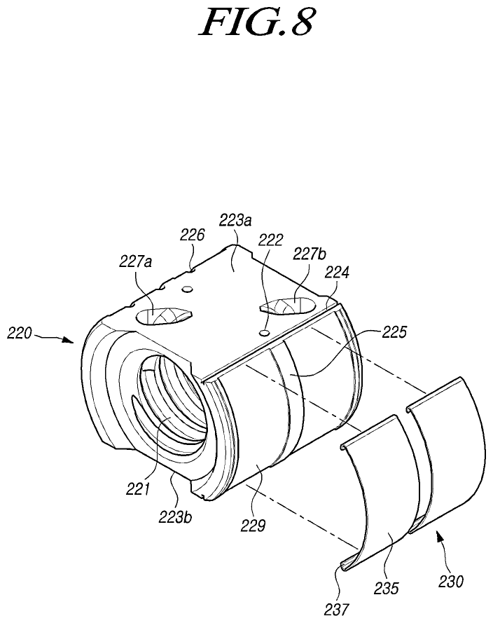

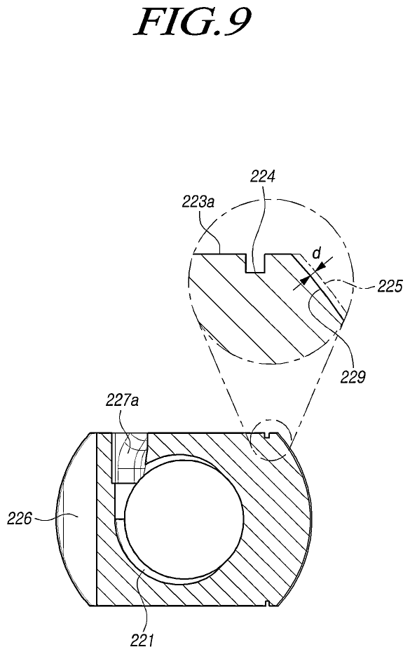

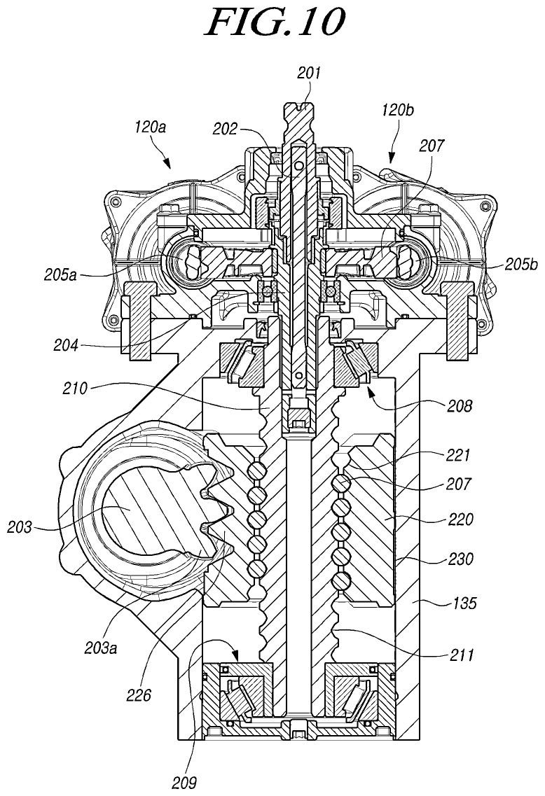

FIG. 1 is a schematic view illustrating an electric power steering apparatus according to the embodiments of the present disclosure, FIGS. 2 to 4 are perspective views illustrating an electric power steering apparatus according to the embodiments of the present disclosure, FIGS. 5 and 6 are exploded perspective views illustrating an electric power steering apparatus according to the embodiments of the present disclosure, FIG. 7 is a cross-sectional view illustrating an electric power steering apparatus according to the embodiments of the present disclosure, FIG. 8 is a exploded perspective view illustrating an electric power steering apparatus according to the embodiments of the present disclosure, FIGS. 9 and 10 are cross-sectional views illustrating an electric power steering apparatus according to the embodiments of the present disclosure.

An electric power steering apparatus according to embodiments of the present disclosure may include a ball screw 210 having an outer screw groove 211 formed on its outer circumferential surface, a ball nut 220 having a gear portion 226 formed on one side of the outer circumferential surface and an inner screw groove 221 corresponding to the outer screw groove 211 formed on the inner circumferential surface, coupled to the ball screw 210 through a ball 207 and sliding in the axial direction, a sector shaft 203 having a shaft gear 203a coupled to the gear portion 226 of the ball nut 220 on an outer circumferential surface and rotating when the ball nut 220 slides in an axial direction, and a sliding support member 230 coupled to the outer circumferential surface of the ball nut 220, supported on an inner circumferential surface of a housing 135, and axially slid together with the ball nut 220.

In the electric power steering apparatus according to according to embodiments of the present disclosure, an angle sensor 105 and a torque sensor 107 are provided on a steering shaft 103 connected to a steering wheel 101. When the driver manipulates the steering wheel 101, the angle sensor 105 and the torque sensor 107 that detect it transmit electrical signals to an electronic control device 110. The electronic control device 110 transmits an operation signal value to a driving motor 120.

The electronic control device 110 controls the operating current value of the driving motor 120 based on the electric signal values input from the angle sensor 105 and the torque sensor 107 and the electric signal values received from other sensors mounted on the vehicle.

In the drawings in embodiments of the present disclosure, for convenience of explanation, an angle sensor 105, a torque sensor 107, a vehicle speed sensor 102, a motor rotation angle sensor 106 are briefly illustrated as an example. However, various radars, lidars, camera image sensors, etc. for transmitting steering information to the electronic control device 110 may be provided, and detailed descriptions of these various sensors will be omitted.

The driving motor 120 may include a first driving motor 120a and a second driving motor 120b.

The driving motor 120 operates the pitman arm 131 connected to the sector shaft 203 through the reducer 130 so that the link 111 connected to the pitman arm 131 is connected to vehicle wheels 119L and 119R and vehicle wheels 119L and 119R are steered through the connected links 115 and 117.

The ball screw 210 has an outer screw groove 211 formed on an outer circumferential surface, and an upper end is coupled to the steering shaft 103 to rotate in conjunction with the steering shaft 103.

The ball nut 220 coupled to the outer peripheral side of the ball screw 210 has a gear portion 226 formed on the outer peripheral surface, and an inner screw groove 221 corresponding to the outer screw groove 211 of the ball screw 210 is formed on the inner circumferential surface of the ball nut 220. Accordingly, the ball nut 220 is coupled to the ball screw 210 via the ball 207 and slides in the axial direction.

The sector shaft 203 disposed in a direction perpendicular to the rotation axis of the ball nut 220 is provided with a shaft gear 203a coupled to the gear portion 226 of the ball nut 220 on the outer peripheral surface. The sector shaft 203 operates the pitman arm 131 while rotating when the ball nut 220 slides in the axial direction.

And, the sliding support member 230 coupled to the outer circumferential surface of the ball nut 220 slides together with the ball nut 220 in the axial direction and is supported on the inner circumferential surface of the housing 135.

The ball nut 220 is formed in a cylindrical shape with an inner screw groove 221 formed on an inner circumferential surface, and cut surfaces 223a and 223b are provided on one side and the other side of the outer circumferential surface at positions opposite to each other. In addition, one cut surface 223a and the other cut surface 223b are connected to a circumferential surface, and a support surface 225 to which the sliding support member 230 is coupled is provided.

That is, the ball nut 220 has cut surfaces 223a and 223b formed at positions opposite to the outer circumferential surface, the gear portion 226 is formed on one side of the remaining outer circumferential surface, and a support surface 225 is formed on the other side opposite to this.

A first communication hole 227a and a second communication hole 227b communicating with the outer screw groove 211 and the inner screw groove 221 are provided on one side and the other side in the axial direction of the cut surface 223a. And, one end and the other end 241 of a ball circulation tube 240 are coupled to the first communication hole 227a and the second communication hole 227b.

The ball circulation tube 240 has one end 241-1 and the other end 241-2 formed in a direction perpendicular to the cut surface 223a, so that one end 241-1 and the other end 241-2 are inserted into the first communication hole 227a and the second communication hole 227b. A connection portion 243 connecting one end 241-1 and the other end 241-2 of the ball circulation tube 240 is formed in a horizontal direction with the cut surface 223a, and is supported and mounted on the cut surface 223a.

In addition, a ball support portion 241a is formed at one end 241-1 and the other end 241-2 of the ball circulation tube 240. The ball support portion 241a protrudes in a wedge shape from one end 241-1 and the other end 241-2 and is disposed in the same direction as the spiral direction of the inner screw groove 221. Therefore, the impact at the time when the ball 207 flows into the inner screw groove 221 through the first communication hole 227a and the second communication hole 227b is reduced, and when the ball 207 circulates a smooth circulation is made without a feeling of jamming.

And, the first communication hole 227a and the second communication hole 227b are provided at a diagonal position of the cut surface 223a.

Therefore, when the ball moves along the inner screw groove 221 and the outer screw groove 211, the ball passes through the first communication hole 227a and the second communication hole 227b through the ball circulation tube 240. Then, the ball circulates again along the inner screw groove 221 of the ball nut 220 and the outer screw groove 211 of the ball screw 210.

A fixing member 250 for fixing the ball circulation tube 240 is coupled to the cut surface 223a of the ball nut 220.

The fixing member 250 includes fixing flanges 255 having both ends coupled to the cut surface 223a, and a close contact portion 253 that is bent between the fixing flanges 255 to surround the outer surface of the ball circulation tube 240 and is in close contact.

In addition, the fixing flanges 255 are provided with a through hole 251 through which a fastening member 270 passes, and a fastening groove 222 is provided in the cut surface 223a of the ball nut 220 at a position corresponding to the through hole 251 of the fixing flanges 255. Accordingly, the ball circulation tube 240 and the fixing member 250 are fixed by the fastening member 270 through the through hole 251 and the fastening groove 222.

The sliding support member 230 is spaced apart from both sides in the axial direction on the support surface 225, and two or more may be coupled thereto.

In addition, a fixing groove 224 formed in the axial direction is formed at the circumferential end of the cut surfaces 223a and 223b, and both ends of the sliding support member 230 are coupled to the fixing groove 224.

The fixing groove 224 is formed to be opened in the axial direction at both ends of the cut surface 223a and 223b.

The sliding support member 230 includes a curved portion 235 that is formed to have the same curvature as the support surface 225, so that the curved portion 235 is in close contact with the support surface 225 and is coupled thereto. Each of both ends of the curved portion 235 is provided with a locking portion 237 bent to be inserted into the fixing grooves 224, respectively.

The locking portion 237 of the sliding support member 230 is bent roundly on the curved portion 235 and the ends are formed perpendicular to the cut surfaces 223a and 223b, and inserted into the fixing groove 224 to prevent separation of the fixing member 250. During assembly, the locking portion 237 moves in the axial direction of the ball nut 220 through the open portion of the fixing groove 224 and is assembled.

On the other hand, the support surface 225 of the ball nut 220 is provided with one or more seating grooves 229 into which the sliding support member 230 is inserted.

The seating groove 229 is radially recessed from the support surface 225 of the ball nut 220, and is spaced apart from both sides in the axial direction of the support surface 225, and two or more may be provided. A sliding support member 230 may be respectively coupled to each of the seating grooves 229.

The depth “d” of the seating groove 229 is formed smaller than the thickness of the sliding support member 230. Accordingly, in a state in which the sliding support member 230 is coupled to the seating groove 229, the sliding support member 230 protrudes from the support surface 225 and is supported by the housing 135.

The sliding support member 230 includes a curved portion 235 coupled to the seating grooves 229, and a locking portion 237 provided at both ends of the curved portion 235 and coupled to the fixing groove 224.

The locking portion 237 of the sliding support member 230 is coupled to the fixing groove 224, and the curved portion 235 of the sliding support member 230 is seated and fixed in the seating groove 229.

In addition, an end of each of the seating grooves 229 and the fixing groove 224 are formed to be spaced apart from each other, so that the locking portion 237 is not separated.

In the electric power steering apparatus according to embodiments of the present disclosure, the electronic control device 110 controls the operating current value of the driving motor 120 based on the electric signal values input from the vehicle speed sensor 104, the motor rotation angle sensor 106, etc. in addition to the electrical signals transmitted from the angle sensor 105 and the torque sensor 107.

The steering shaft 103 may include an input shaft 201 and an output shaft 204, and is rotated by the reducer 130 connected to the driving motor 120. When the steering shaft 103 is integrally provided according to the layout of the engine room of the vehicle, the steering shaft 103 itself may be the input shaft 201. Also, when two or more steering shafts 103 are bent by a universal joint or the like, the steering shaft 103 may be coupled to the input shaft 201.

And, the input shaft 201 and the output shaft 204 are hollow, and the torsion bar 202 is coupled to the inner space. A torque sensor for detecting steering torque generated when the driver manipulates the steering wheel is provided on the outer peripheral side of the input shaft 201.

And, in order to prevent the driving motor 120 from becoming incapable of steering when an error occurs, the driving motor 120 may include a first driving motor 120a and a second driving motor 120b.

The reducer 130 includes a first gear member 205a and a second gear member 205b coupled to the first driving motor 120a and the second driving motor 120b respectively to rotate, and a third gear member 207 coupled to the first gear member 205a and the second gear member 205b to rotate the output shaft 204 when the first driving motor 120a and the second drive motor 120b rotate.

The first gear member 205a and the second gear member 205b are connected to the shafts of the first driving motor 120a and the second driving motor 120b, respectively, and rotate in interlock with the third gear member 207. Here, the first gear member 205a, the second gear member 205b, and the third gear member 207 may be worm and worm wheel gears or bevel gears, etc. In the present disclosure, a worm and worm wheel gear is shown as an example.

A first rotation support member 208 for supporting the rotation of the ball screw 210 is provided between the upper end of the ball screw 210 and the housing 135. A second rotation support member 209 for supporting the rotation of the ball screw 210 is provided between the lower end of the ball screw 210 and the housing 135.

In addition, in some cases, when one of the motors becomes inoperable or a greater steering force is required, the electronic control device can generate a higher output for the other motor.

That is, the electronic control device compares the signal detected by the motor rotation angle sensor 106 that detects the operating state of each of the first driving motor 120a and the second driving motor 120b with preset data. And, when it is determined that one of the motors is inoperable or there is an error, the electronic control device may increase or decrease the output of the other motor accordingly.

As described above, according to embodiments of the present disclosure, the amplified steering torque is transmitted through the reducer in the case of a truck or bus that requires a relatively large steering force compared to a passenger car, and it is possible to increase the convenience of the driver by improving the durability of power transmission parts such as ball nuts, ball screws, sector shafts, and housings.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. An electric power steering apparatus comprising:
a ball screw having an outer screw groove formed on its outer circumferential surface;
a ball nut having a gear portion formed on one side of the outer circumferential surface and an inner screw groove corresponding to the outer screw groove formed on the inner circumferential surface, coupled to the ball screw through a ball and sliding in the axial direction;
a sector shaft having a shaft gear coupled to the gear portion of the ball nut on an outer circumferential surface and rotating when the ball nut slides in an axial direction; and
a sliding support member coupled to the outer circumferential surface of the ball nut, supported on an inner circumferential surface of a housing, and axially slid together with the ball nut.

2. The electric power steering apparatus of claim 1, wherein the ball nut is provided with a cut surface on one side and the other side of the outer circumferential surface so that one cut surface and the other cut surface are connected to the circumferential surface, and a support surface to which the sliding support member is coupled is provided.

3. The electric power steering apparatus of claim 2, wherein a first communication hole and a second communication hole communicating with the outer screw groove and the inner screw groove are provided on one side and the other side of the cut surface, and a ball circulation tube is coupled to the first communication hole and the second communication hole.

4. The electric power steering apparatus of claim 3, wherein the ball circulation tube has one end and the other end formed in a vertical direction with the cut surface and inserted into the first communication hole and the second communication hole, and a connection portion connecting the one end and the other end is formed in a horizontal direction with the cut surface and the supported on the cut surface.

5. The electric power steering apparatus of claim 3, wherein at one end and the other end of the ball circulation tube, a ball support portion protruding in a wedge shape and disposed in the same direction as the spiral direction of the inner screw groove is formed.

6. The electric power steering apparatus of claim 3, wherein the first communication hole and the second communication hole are provided at a diagonal position of the cut surface.

7. The electric power steering apparatus of claim 3, wherein a fixing member for fixing the ball circulation tube is coupled to the cut surface.

8. The electric power steering apparatus of claim 7, wherein the fixing member comprises:
fixing flanges having both ends coupled to the cut surface; and
a close contact portion that is bent between the fixing flanges to surround the outer surface of the ball circulation tube and is in close contact.

9. The electric power steering apparatus of claim 8, wherein a through hole through which a fastening member passes is provided in each of the fixing flanges, and a fastening groove is provided in a position corresponding to the through hole in the cut surface.

10. The electric power steering apparatus of claim 2, wherein the sliding support member is spaced apart from both sides in the axial direction of the support surface, and two or more are coupled.

11. The electric power steering apparatus of claim 2, wherein a fixing groove formed in the axial direction is formed at a circumferential end of the cut surface and both ends of the sliding support member are coupled to the fixing groove.

12. The electric power steering apparatus of claim 11, wherein the fixing groove is formed to be opened in the axial direction at both ends of the cut surface.

13. The electric power steering apparatus of claim 10, wherein the sliding support member has a curved portion in close contact with the support surface, and each of both ends of the curved portion is provided with a locking portion bent to be inserted into the fixing groove.

14. The electric power steering apparatus of claim 2, wherein the support surface is provided with one or more seating grooves into which the sliding support member is inserted.

15. The electric power steering apparatus of claim 14, wherein the seating grooves are disposed to be spaced apart from each other in the axial direction of the support surface, and the sliding support member is coupled to each of the seating grooves.

16. The electric power steering apparatus of claim 11, wherein a fixing groove formed in the axial direction is formed at a circumferential end of the cut surface.

17. The electric power steering apparatus of claim 16, wherein the sliding support member comprises:
a curved portion coupled to the seating grooves; and
a locking portion provided at both ends of the curved portion and coupled to the fixing groove.

18. The electric power steering apparatus of claim 16, wherein an end of each of the seating grooves and the fixing groove are formed to be spaced apart from each other.
